(19) United States
(12) Patent Application Publication
(10) Pub. No.: US 2010/0020994 A1
(43) Pub. Date: Jan. 28, 2010

(54) Antenna integrated with retrieval component of hearing aid

(76) Inventors: Craig L. Christensen, Pocatello, ID (US); Andrei R. Petrov, Pocatello, ID (US)

Correspondence Address: Workman Nydegger;1000 Eagle Gate Tower, 60 East South Temple, Salt Lake City, UT, 84111, US

(21) Appl. No.: 10/975,914

(22) Filed: Oct. 28, 2004

(51) Int. Cl. H04R 25/00

(52) U.S. Cl. 381/315

(57) ABSTRACT

A hearing aid that includes an antenna attached to the retrieval component. Since the retrieval component extends outside of the ear canal when the main body of the hearing aid is placed within the ear canal, the attached antenna also extends outside of the ear canal. Thus, much of any received wireless signals are not shield by the ear canal, but are received directly by the antenna. Furthermore, the antenna may transmit wireless signals externally to the ear, rather than having the signals be blocked by the ear canal. This enables more reliable wireless communication with the main body of the ear canal.

### BACKGROUND OF THE INVENTION

1. The Field of the Invention

The present invention relates generally to hearing aids. More specifically, the present invention relates to the integration of an antenna with a retrieval component of a hearing aid for wireless communication with the hearing aid.

2. Background and Relevant Art

The ability to sense one's surroundings is important to the quality of life of any human being. The five senses typically attributed to human beings include sight, hearing, touch, taste, and smell. However, it is not at all unusual for a human being to have partial or even complete impairment in any one or more of these senses. Hearing impairments, in particular, are especially common. Hearing is indeed an important sensory ability as sound is a primary means for human communication. Due to the importance of hearing and the widespread nature of hearing impairments, hearing impairments in the aggregate have historically had a significant adverse effect on the plight of humanity.

To improve this condition, hearing aids have been developed. Some hearing aids can be placed deep within the ear canal of a user to amplify sound for the user. Accordingly, sounds that were once below the user's hearing threshold are brought above the hearing threshold. At times when the user desires to hear better, the hearing aid may be inserted into the ear canal. However, the hearing aid is typically not permanently inserted into the ear canal. There are numerous instances in which it is desirable or advisable to remove the hearing aid.

For instance, the hearing aid may be removed occasionally for patient comfort and/or at times when the hearing ability is less important or even undesirable such as during sleep. The hearing aid may also be removed in cases when the hearing aid is to be subjected to cleaning, battery replacement, or other maintenance. Furthermore, the hearing aid may be removed to avoid getting the hearing aid wet such as prior to swimming, showering, or bathing. There are also many other instances in which the hearing aid may be removed.

This frequent removal can be difficult considering how deep the hearing aid may be inserted into the ear canal. Accordingly, many hearing aids have a retrieval component that extends from the main body of the hearing aid. When the main body of the hearing aid is properly placed within the ear canal, the retrieval component extends slightly outside of the hearing aid. In this configuration, the patient may easily remove the hearing aid by grasping and pulling the retrieval component to thereby pull the connected main body of the hearing aid out of the ear canal.

FIG. 4 illustrates a conventional hearing aid 400 that includes a main body 401 and a retrieval component 402. The main body 401 is inserted deep into the ear canal and performs the actual amplification. The retrieval component 402 is in this case a line that extends outside of the ear canal once the main body 401 is properly placed in the ear canal. The retrieval component 402 is often called a retrieval line. The retrieval line is normally constructed as a translucent or clear monofilament line which has a small bulbous tip 403 to provide a more secure grip.

The retrieval component allows the user to physically interact with the main body of the hearing aid. Accordingly, some hearing aid manufacturers have allowed the user to physically interact with the hearing aid in ways in addition to just hearing aid retrieval. For example, on some hearing aid devices, the retrieval component is also used to allow the patient to adjust the volume of the hearing aid. On other hearing aids, the retrieval component is used to turn the hearing aid on and off. The retrieval component may also be used to allow the hearing aid to physically interact with the outside of the ear canal. For example, some documents describe a hearing aid retrieval line in which the retrieval line also serves as a vent for the hearing aid.

As wireless technology has developed, wireless communication has been incorporated into a variety of devices. Wireless enabled hearing aids have been developed to allow for wireless communication with the hearing aid. Such wireless enabled hearing aids typically (if not always) operate on the principle of inductive pickup. However, there are considerable problems with such wireless communication. In particular, if the hearing aid is deep within the ear canal, human tissue and/or bones often shield the hearing aid from properly receiving wireless signals.

In order to properly receive a wireless signal using inductive pickup, the position of the hearing aid receiver with respect to the inductive pickup transmitter often needs to be adjusted until a proper signal is received. This represents a significant inconvenience for the user. Often, the inductive receiver is placed outside of the ear. However, hearing aid users often desire the hearing aid to be as inconspicuous as possible. Having large components outside of the ear makes the hearing aid more conspicuous and therefore less desirable to the user.

Accordingly, what would be advantageous is a hearing aid that has improved ability to wirelessly communicate, despite being deep within the ear canal.

### BRIEF SUMMARY OF THE INVENTION

The foregoing problems with the prior state of the art are overcome by the principles of the present invention, which relate to a hearing aid that includes an antenna attached to the retrieval component. Since the retrieval component extends outside of the ear canal when the main body of the hearing aid is placed within the ear canal, the attached antenna also extends outside of the ear canal. Thus, much of any received wireless signals are not shielded by the ear canal, but are received directly by the antenna. Furthermore, signals transmitted from the antenna may reach external to the ear without being blocked by the ear canal. This enables more reliable wireless communication between the main body of the hearing aid within the ear canal and the outside world. Furthermore, the integrated retrieval component and antenna is not much more conspicuous that the retrieval component itself, thereby enabling inconspicuous and convenient wireless communication with the hearing aid.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram of a hearing aid having an integrated retrieval component and antenna in accordance with the principles of the present invention and in which the retrieval component is a retrieval line;

FIG. 2A illustrates a first example perspective cross-sectional view of the integrated retrieval component and antenna in which the antenna is embedded within the retrieval component;

FIG. 2B illustrates a second example perspective cross-sectional view of the integrated retrieval component and antenna in which the antenna is attached to the outside of the retrieval component;

FIG. 3 is a diagram of a hearing aid having an integrated retrieval component and antenna in accordance with the principles of the present invention and in which the retrieval component is a retrieval loop; and

FIG. 4 is a diagram of a hearing aid in accordance with the prior art in which the hearing aid has a retrieval component in the form of a retrieval line.

### DETAILED DESCRIPTION OF THE PREFERRED EMBODIMENTS

The principles of the present invention relate to hearing aids that have an antenna, at least some of which being integrated with a retrieval component. The retrieval component extends outside of the ear canal even when the main body of the hearing aid is properly placed in the ear canal. Accordingly, portions of the antenna also extend outside of the ear canal, enabling the antenna to efficiently receive and transmit wireless signals. Furthermore, this wireless communication does not rely on large components being placed outside of the ear thereby reducing the visual profile and increasing the comfort of the hearing aid.

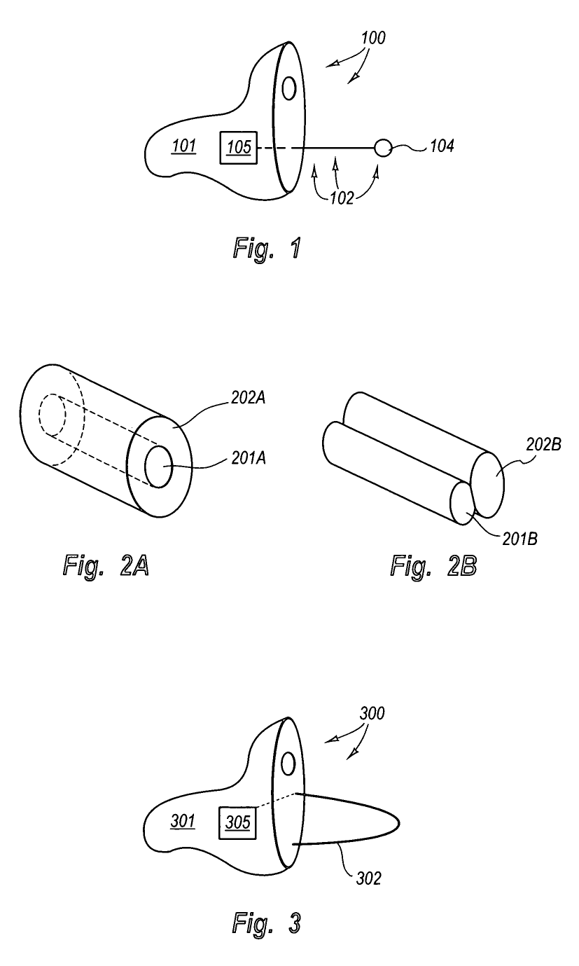

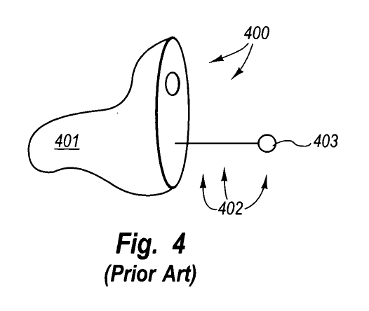

FIG. 1 illustrates a wireless hearing aid device 100 in accordance with the principles of the present invention. The wireless hearing aid device 100 includes a main body 101 that is inserted into the ear canal of the user for amplification of sound during operation. The wireless hearing aid device 100 also includes an integrated retrieval component and antenna 102 (hereinafter also referred to as an “integrated component”). The integrated component 102 includes a retrieval component connected to the main body 101 so as to extend outside of the ear canal when the main body 101 is placed within the ear canal. This retrieval component may extend from the main body 101 and terminate at the bulbous tip 104.

The integrated component 102 also includes at least part of an antenna connected to the retrieval component so as to also extend outside of the ear canal when the main body is placed within the ear canal. The antenna may also extend from the main body 102 along most or all of the length of the retrieval component. Accordingly, portions of the antenna lie outside of the ear canal during operation, enabling the antenna to efficiently receive and transmit wireless signals. The antenna may also include other portions that are not necessarily integrated with the retrieval component. For example, a hearing aid battery may be used for the ground plane for the antenna, and/or a base-loading inductor may be used for antenna matching.

In FIG. 1, although the integrated component 102 is visible, it is not possible to distinguish the retrieval component from the connected antenna. It is not critical how the antenna is connected to the retrieval component. However, FIGS. 2A and 2B show two example perspective cross sections of short segments of the integrated component 102, which are provided to show possible structural relations between the retrieval component and the antenna.

In FIG. 2A, the antenna 201A is embedded within and along the length of the retrieval component 202A. The antenna 201A is composed of a conductive material such as metal. The retrieval component 202A may be composed of a plastic or any other structurally sound material. Methods for forming structures in which a long member of a higher melting temperature is longitudinally embedded within another long member of a lower melting temperature are known in the art and thus will not be described in detail here.

In FIG. 2B, the antenna 201B is longitudinally attached to the exterior of the retrieval component 202B. The antenna 201B may be bonded to the retrieval component 202B using any conventional mechanism for bonding a conductive material such as metal to a structurally supported material such as plastic. There are many such conventional bonding mechanisms that may be employed to attach the antenna 201B to the retrieval component 202B.

Returning to FIG. 1, the antenna that is part of the integrated component 102 is electrically coupled to wireless circuitry 105, which may be used to interpret data received by the antenna and/or generate data transmitted by the antenna. This coupling is symbolically represented using a dashed line. The wireless circuitry 105 may be any conventional receiver circuitry capable of receiving electrical signals from an antenna and converting such signals into data and/or generating data for transmission using the antenna. Received data may then be consumed by the hearing aid to assist the hearing aid in proper operation, thereby completing a wireless link between a companion wireless device and the hearing aid. For example, the wireless link may be used for initial setup, configuration, and tuning of the hearing aid. The wireless link may also be used for control of various functions of the hearing aid or for the transmission of audio to the hearing aid. Alternatively or in addition, transmitted data may be used by the companion device. Transmitted data may include, for example, diagnostic information regarding hearing aid performance or status.

FIG. 3 illustrates a wireless hearing aid 300 in accordance with a second embodiment of the present invention. The wireless hearing aid 300 of FIG. 3 is similar to the wireless hearing aid 100 of FIG. 1. For instance, the main body 301 and the receiver circuitry 305 may be similar to the main body 101 and the receiver circuit 105. However, in the case of FIG. 3, the integrated retrieval component and antenna 302 is a loop. Also in this case, the integrated component 302 may have the cross-sectional characteristics illustrated in FIGS. 2A and 2B.

Accordingly, the principles of the present invention provide a hearing aid that efficiently performs wireless communication. This is true regardless of whether the wireless communication mechanism is via inductive pickup or normal radio communication using transmitted electromagnetic radiation. Furthermore, the wireless communication does not rely on external devices of significant size to be worn by the user. This makes the hearing aid relatively inconspicuous and improves user comfort.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. A hearing aid comprising the following:
a main body configured to amplify sound during operation;
a retrieval component connected to the main body;
an antenna connected to the retrieval component.
wireless circuitry electrically coupled to the antenna,
wherein the wireless circuitry is configured to use the antenna to transmit diagnostic information regarding the hearing aid.

2. A hearing aid in accordance with claim 1, wherein the retrieval component is a retrieval line.

3. A hearing aid in accordance with claim 1, wherein the retrieval component is a retrieval loop.

4. A hearing aid in accordance with claim 1, wherein the antenna is connected to the retrieval component by having at least a portion that is embedded within the retrieval component.

5. A hearing aid in accordance with claim 1, wherein the antenna is connected to the retrieval component by being attached to the outside of the retrieval component.

6. (canceled)

7. An integrated hearing aid retrieval component and antenna comprising the following:
a retrieval component configured to be attached to a main body of a hearing component; and
an antenna connected to the main retrieval member, wherein the antenna is used to transmit diagnostic information regarding the hearing aid.

8. An integrated hearing aid retrieval component and antenna in accordance with claim 7, wherein the retrieval component is a retrieval line.

9. An integrated hearing aid retrieval component and antenna in accordance with claim 7, wherein the retrieval component is a retrieval loop.

10. An integrated hearing aid retrieval component and antenna in accordance with claim 7, wherein the antenna is connected to the retrieval component by having a least a portion that is embedded within the retrieval component.

11. An integrated hearing aid retrieval component and antenna in accordance with claim 7, wherein the antenna is connected to the retrieval component by being attached to the outside of the retrieval component.

12. A hearing aid comprising the following:
a main body configured to be placed within an ear canal of a human being during operation, the main body configured to amplify sound during operation;
a retrieval component connected to the main body so as to extend outside of the ear canal when the main body is placed within the ear canal, and
an antenna connected to the retrieval component so as to also extend outside of the ear canal when the main body is placed within the ear canal, wherein the antenna is used to transmit diagnostic information regarding the hearing aid.

13. A hearing aid in accordance with claim 12, wherein the retrieval component is a retrieval line.

14. A hearing aid in accordance with claim 12, wherein the retrieval component is a retrieval loop.

15. A hearing aid in accordance with claim 12, wherein the antenna is connected to the retrieval component by having at least a portion that is embedded within the retrieval component.

16. A hearing aid in accordance with claim 12, wherein the antenna is connected to the retrieval component by being attached to the outside of the retrieval component.

17. A hearing aid in accordance with claim 12, wherein the main body of the hearing aid further comprises the following:
wireless circuitry connected to the antenna.

18. A hearing aid retrieval component the following:
a main retrieval member configured to bear most of the tensile stress when used to remove a main body of a hearing component when the main body of the hearing component is attached to the main retrieval component and inserted into an ear canal of a human being;
an antenna connected to the main retrieval member so as to also extend outside of the ear canal when the main body attached to the main retrieval component and when the main body is placed within the ear canal; and
wireless circuitry electrically coupled to the antenna,
wherein the wireless circuitry is configured to use the antenna to transmit diagnostic information regarding the hearing aid.

19. A hearing aid retrieval component in accordance with claim 18, wherein the retrieval component is a retrieval line.

20. A hearing aid retrieval component in accordance with claim 18, wherein the retrieval component is a retrieval loop.

21. A hearing aid retrieval component in accordance with claim 18, wherein the antenna is connected to the main retrieval member by having at least a portion that is embedded within the main retrieval member.

22. A hearing aid retrieval component in accordance with claim 18, wherein the antenna is connected to the main retrieval member by being attached to the outside of the main retrieval member.

23. A hearing aid retrieval component in accordance with claim 4, wherein the portion that is embedded within the retrieval component comprises:
a hearing aid battery used as a ground plane for the antenna.

24. A hearing aid retrieval component in accordance with claim 4, wherein the portion that is embedded within the retrieval component comprises:
a base-loading inductor used for antenna matching of the antenna.

25. A method for operating a hearing aid that includes a main body that amplifies sound during operation, a retrieval component connected to the main body, an antenna connected to the retrieval component, and wireless circuitry electrically coupled to the antenna, the method comprising:
an act of inserting the main body of the hearing aid into a human ear canal;
while the hearing aid is within the human ear canal, an act of the hearing aid performing diagnostics on the hearing aid; and
an act of the wireless circuitry using the antenna to transmit results of the diagnostics wirelessly while the hearing aid is still within the human ear canal; and
an act of using the retrieval component to remove the hearing aid from the human ear canal.
